(19) United States
(12) Patent Application Publication
(10) Pub. No.: US 2025/0245644 A1
(43) Pub. Date: Jul. 31, 2025

(54) INTELLIGENT PROCESSING OF OPEN ITEMS IN MIXED RESOURCE ALLOCATION SCENARIOS

(71) Applicant: SAP SE, Walldorf (DE)

(72) Inventor: Xin Cao, Shanghai (CN)

(21) Appl. No.: 18/428,355

(22) Filed: Jan. 31, 2024

(51) Int. Cl. G06Q 20/22

(52) U.S. Cl. CPC G06Q 20/227

(57) ABSTRACT

Embodiments describe techniques for assigning a large volume of open items associated with a external entity to a diverse range of allocation methods. A user may define a planned target resource amount for each allocation method and an allocation strategy configuration. The open item matching tool may receive these information and begin assigning open items to the different allocation methods in a manner that satisfies the constraints provided in the allocation strategy configuration.

### BACKGROUND

Unless otherwise indicated herein, the approaches described in this section are not prior art to the claims in this application and are not admitted to be prior art by inclusion in this section.

In situations where an available resource is limited and where it needs to be distributed between different entities and using different methods of how the resource is allocated to a respective receiving entity, a smart allocation strategy needs to be found. An example is a business owner buying goods and services from suppliers. Each good or service purchased generates a supplier invoice that includes details about the purchase, such as the amount owed to the supplier. The supplier invoices that have not been settled yet are known as open items. In large businesses, there can be thousands of open items at any point in time, making it difficult for the business owner to prioritize the settlement of the open items. Thus, there is a need to intelligently process the open items.

### BRIEF DESCRIPTION OF THE DRAWINGS

FIG. 1 illustrates a system for assigning open items to an allocation method according to some embodiments.

FIG. 2 illustrates an exemplary assignment of open items to allocation methods according to some embodiments.

FIG. 3 illustrates an exemplary open item data structure according to some embodiments.

FIG. 4 illustrates an exemplary allocation strategy configuration according to some embodiments.

FIG. 5 illustrates a workflow for assigning open items to an allocation method according to some embodiments.

FIGS. 6A and 6B illustrate a workflow for assigning open items to an allocation method according to some embodiments.

FIG. 7 depicts a simplified block diagram of an example computer system 400, which can be used to implement some of the techniques described in the foregoing disclosure.

### DETAILED DESCRIPTION

Described herein are methods and apparatuses to assign a large volume of open items associated with an external entity, e.g., a supplier, to different allocation methods for allocating a resource that has a predefined amount, e.g. allocating a financial resource with a predefined payment amount, in an intelligent manner. For example, in a mixed allocation scenario, a user may try to assign open items to a variety of allocation methods, which can include cash, bank transfer, cheque, payable bill of exchange, and receivable bill of exchange. As an additional aspect, it may be difficult for the user to manually assign open items to allocation methods in an efficient manner, let alone in a manner that is optimized for the user's preferences or allocation strategy. Thus, there is a need for an open item matching tool that is capable of matching open items to allocation methods according to the user's allocation strategy. As described herein, matching open items to an allocation method is analogous to assigning open items to a payment method.

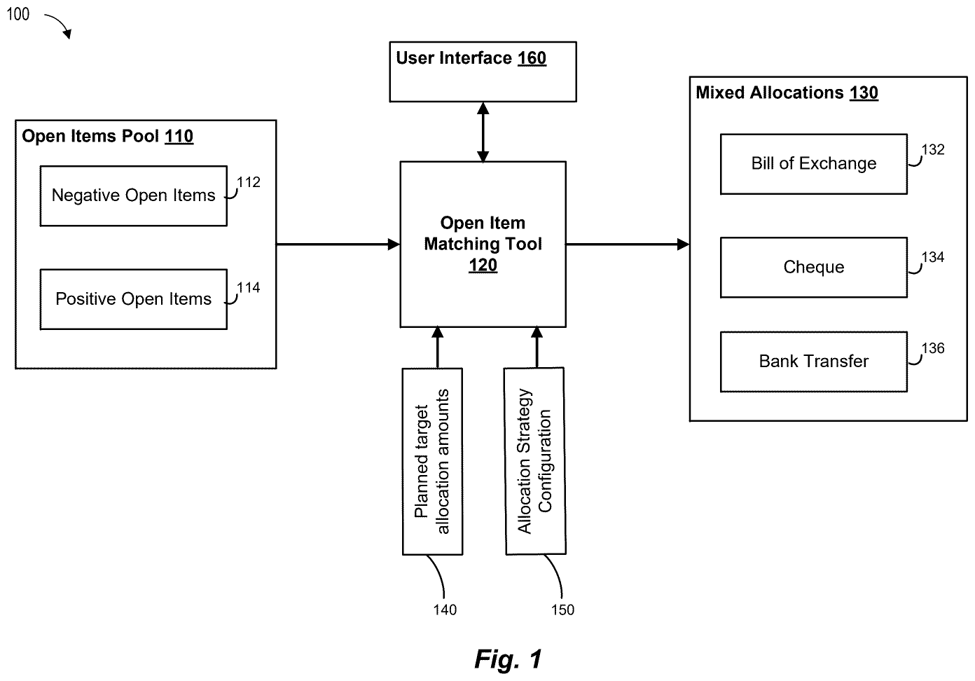

FIG. 1 illustrates a system for assigning open items to an allocation method according to some embodiments. System 100 includes open items pool 110, open item matching tool 120, and mixed allocations 130. Open items pool 110 may be stored in a storage medium which may be internal or external to a computing device. Examples of storage medium include solid state drives, hard drives, USB flash drives, and non-volatile memory. Open items pool 110 includes negative open items 112 and positive open items 114 and all open items may be associated with a single external entity, which may be a supplier, vendor, or any third party that is doing business with the user. An open item is considered an invoice that has been issued by a seller or vendor that has yet to be processed by the business owner. An invoice is considered a closed item once it has been fully processed. Negative open items are open items which have a negative amount. Examples of negative open items in connection with payment of invoices include rebates for the purchase of goods/services, returns of goods/services, or refunds for the overpayment of good/services. Positive open items are open items which have a positive amount. Examples of positive open items in connection with payment of invoices include the purchase of good/services from a supplier or vendor. In some examples, open items pool 110 may include a large set of open items that include both positive open items mixed along with negative open items.

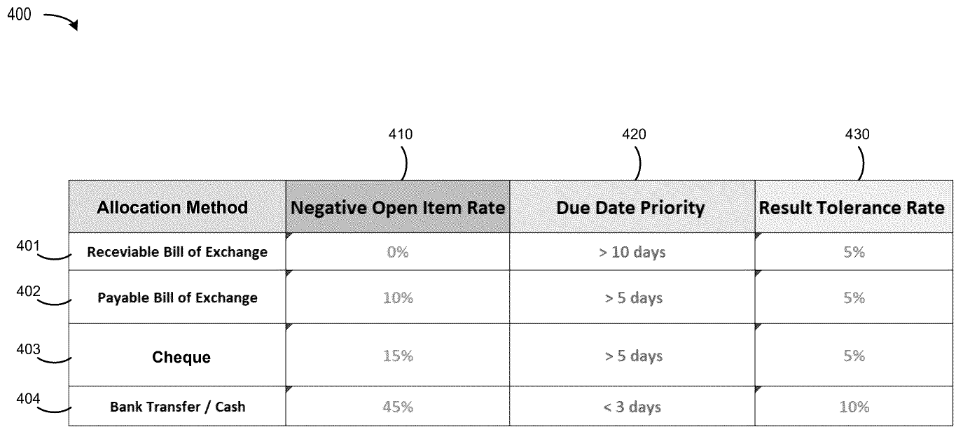

Open item matching tool 120 may be configured to assign open items from open items pool 110 to one of the allocation methods in mixed allocations 130. As shown here, mixed allocations 130 may include bank transfer bill of exchange 132, cheque 134, and bank transfer 136. Mixed allocation 130 may be stored in computer storage medium which may be internal or external to a computing device. In some examples, the computer storage medium may be the same storage medium storing open items pool 110. Open item matching tool 120 may receive planned target allocation amounts 140 and allocation strategy configuration 150, which define how the tool will assign open items to the allocation methods. Planned target allocation amounts 140 may be defined by a user as the target amount of the resource that the user plans to allocate to the external entity. A planned target allocation amount may be defined for each allocation method that the user plans on making an allocation with. Allocation strategy configuration 150 may include settings that define the user's strategy in assigning open items to allocation methods. An exemplary allocation strategy configuration is shown in FIG. 4. User interface 160 may be utilized by a user to communicate with open item matching tool 120. The communication can include providing instructions to the open item matching tool 120 to generate mixed allocations 130, to define planned target allocation amounts 140, to define allocation strategy configuration 150 and other instructions. In response to the communication, open item matching tool 120 may generate mixed allocations 130 and provide mixed allocations 130 to the user through user interface 160.

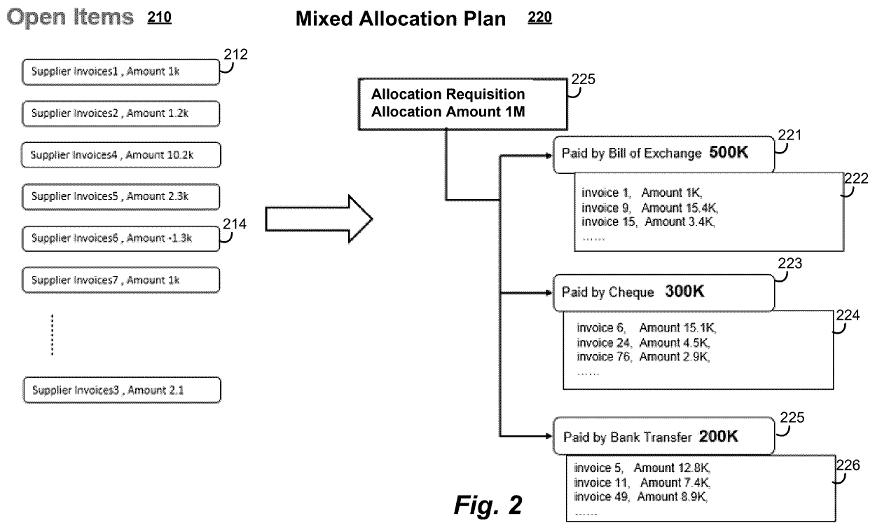

FIG. 2 illustrates an exemplary assignment of open items to allocation methods according to some embodiments. As shown, open items pool 210 includes a set of open items, which include positive open item 212 and negative open item 214. An open item matching tool may receive open items pool 210 and assign the open items to allocation methods, resulting in mixed allocation plan 220. Mixed allocation plan 220 can include allocation requisition 225 which describes the total allocation amount (in this example is $1 million dollars). The open items in mixed allocation plan 220 can be split up by the allocation method. Here, open items 222 are to be paid by bill of exchange 221, open items 224 are to be paid by cheque 223, and open items 226 are to be paid by bank transfer 225. In one embodiment, additional information may be added to an open item once the open item is assigned to an allocation method. For example if an open item is assigned to be paid by check, a check number may be added to the open item. Similarly if an open item is to be assigned to be paid by bank transfer, a bank account number may be added to the open item. Similarly, a Bill of Exchange number may be added to an open item once it has been assigned to be paid by Bill of Exchange. As shown, mixed allocation plan 220 includes a planned target allocation amount of 500 k by bill of exchange 221, 300 k by cheque 223, and 200 k by bank transfer 225. While a planned allocation target amount of a given allocation method may be the desired goal, the actual total or sum of the invoices to be paid by an allocation method may be close, but not equal to, the desired goal due to the open items available. For example, while the planned target payment amount for bank transfer may be 200 k, the actual payment amount for bank transfer may be slightly under at 199.5 k or slightly over at 200.8 k. In yet other examples, no additional information may be added to an open item once the open item is assigned to an allocation method.

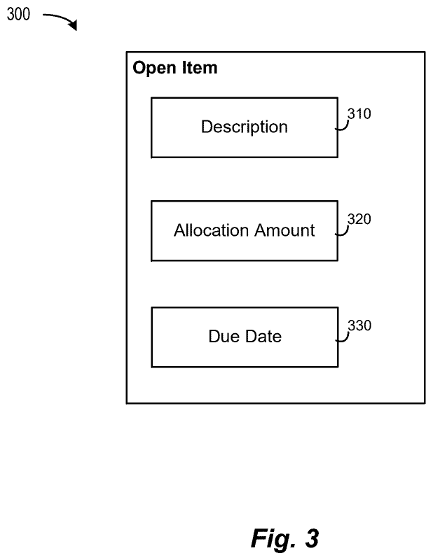

FIG. 3 illustrates an exemplary open item data structure according to some embodiments. Open item 300 includes description 310, allocation amount 320, and due date 330. Description 310 can for example include information about an invoice associated with the open item. This can include an invoice number and/or details on the goods or services that the invoice is related to. Allocation amount 320 can be a numerical value that identifies the amount of money that is to be processed to close the invoice. For example, allocation amount 320 can be a positive number when the amount is to be paid to an external entity (also known as a positive open item) or can be a negative number when a refund or rebate is due (also known as a negative open item). Due date can be the calendar date that the open item should be processed by. For example a due date of 12/31/23 would mean that the open item should be processed on or before 12/31/23 to be deemed on time. Processing the open item after 12/31/23 would mean that the open item has been processed late. In other examples, open item 300 can include more or fewer parameters.

FIG. 4 illustrates an exemplary allocation strategy configuration according to some embodiments. Allocation strategy configuration 400 may be received by open item matching tool 120 of FIG. 1 to define the strategy for assigning open items to allocation methods. As shown here, allocation strategy configuration 400 may be represented as a table that includes rows for each allocation method (receivable bill of exchange 401, payable bill of exchange 402, cheque 403, and bank transfer/cash 404) and columns defining different parameters of the allocation strategy. In different embodiments, more or fewer columns may be present depending on the number of parameters in the allocation strategy.

Column 410 defines the negative open item rate. The negative open item rate is a percentage value between 0-100% that defines the negative target allocation amount for a given allocation method. As mentioned above, each open item may be a positive open item (meaning that the corresponding invoice contains an allocation amount due) or a negative open item (meaning that the corresponding invoice contains a credit or rebate due). In one embodiment, the negative target allocation amount defines the target sum of negative open items that may be assigned to the allocation method. For example if the negative target payment amount is $1000 for the cheque payment method, then the open item matching tool may assign a first negative open item with an invoice of $500 credit, a second negative open item with an invoice of $400 credit, and a third negative open item with a invoice of $50 credit, thus totaling a credit of $950. In one embodiment, the negative target allocation amount sets the maximum for the sum of the negative open items. In other embodiments a tolerance rate may be applied to the negative target allocation amount to provide a range of values that the negative target allocation amount may be. In one embodiment, the planned target allocation amount for an allocation method is multiplied by the negative open item rate to calculate the negative target allocation amount. For example if the total target payment amount for bank transfer is $200 k and the negative open rate for bank transfer is 45%, then the negative target payment amount for bank transfer would be $90 k.

Column 420 defines the due date priority which may be used by the open item matching tool to filter through the positive open items according to due date. As described above, positive open items correspond to an invoice with an allocation due and the external entity may have an agreement in place that the allocation is due within a predetermined period of time. For example, an external entity may request that all allocations be made within 60 days of delivery. The due date priority configuration allows the user to configure the allocation strategy to prioritize earlier due dates for certain kinds of allocations. As shown in allocation strategy configuration 400, positive open items with due dates within three days are prioritized for bank transfers/cash, positive open items with due date more than 10 days away are prioritized for receivable bill of exchange, positive open items with due dates more than 5 days away are prioritized for payable bill of exchange or cheque. As mentioned, negative open items correspond to a credit or rebate and thus can be claimed at any time to offset allocations due.

Column 430 defines the result tolerance rate which may be used by the open item matching tool to define a margin of error that is acceptable. Depending on the implementation, the margin of error can be for the negative target allocation amount, the positive target allocation amount, or the planned target allocation amount. For example by setting a result tolerance rate of 5% for the planned target payment amount of $1000 for the cheque payment method, the open item matching tool would assign open items to the cheque payment method up until the sum of the invoice amounts is between $950 and $1050 (i.e., $1000, plus or minus 5%). A result tolerance rate may be assigned for each payment method or for each target payment amount.

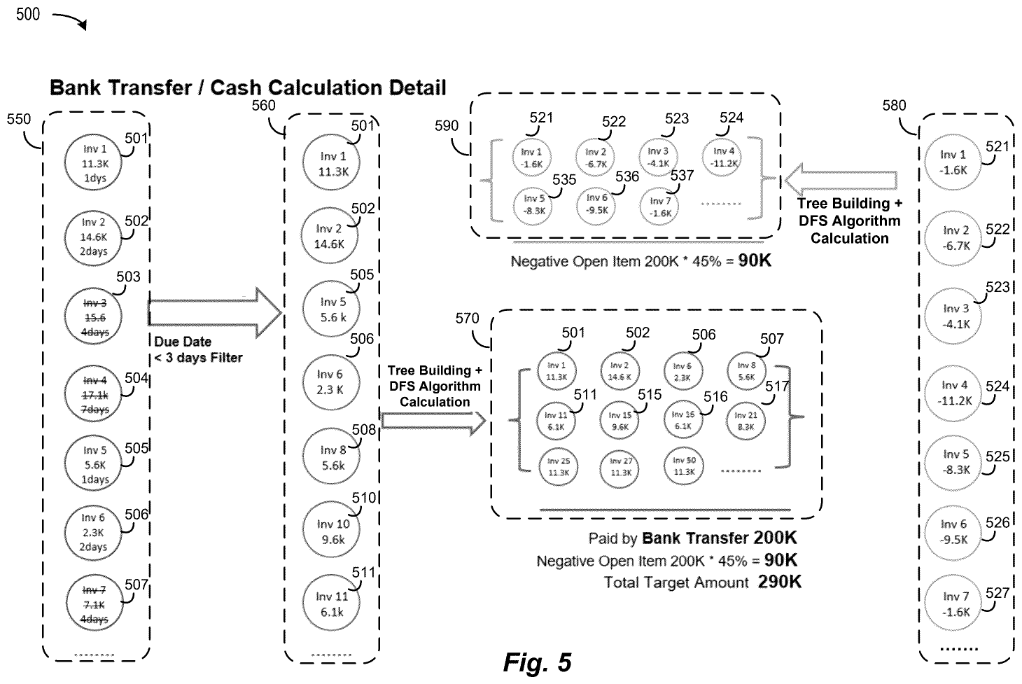

FIG. 5 illustrates a workflow for assigning open items to an allocation method according to some embodiments. As shown, workflow 500 may assign positive open items from set 550 and negative open items from set 580 to a specific allocation method, for example a bank transfer/cash payment methods. Set 580 includes all negative open items that have yet to be assigned. Negative open items 521-527 are shown here as a part of set 580 but it is to be understood that set 580 includes more negative open items than shown. Workflow 500 begins by calculating the negative target allocation amount for the specific allocation method by multiplying the planned target allocation amount ($200 k) by the negative open item rate (45%). The negative open item rate may be retrieved from the allocation strategy configuration. Thus, the negative target allocation amount is calculated, for example as $90 k. Workflow 500 then continues by generating a tree structure from negative open items in set 580 (where each negative open item is associated with a node in the tree structure) and performing a traversal on the generated tree structure to select negative open items. For example, each negative open item may be associated with an invoice that has a rebate or credit amount. As the generated tree structure is traversed, workflow 500 maintains a total of the negative allocation amounts of the negative open items traversed. When the total is close to the negative target allocation amount ($90 k), the traversal ends. In one embodiment, the traversal ends when the total is larger than the negative target allocation amount, or when all negative open items have been traversed. In one another embodiment, the traversal ends when the total is close to but does not exceed the negative target allocation amount, or when all negative open items have been traversed. In another embodiment, the traversal ends when the total is within a margin of the negative target allocation amount, or when all negative open items have been traversed. Here, the total is $90 k, the same amount as the negative target allocation amount. Set 590 is the set of negative open items traversed and includes negative open items 521-524 and 535-537. Workflow 500 may complete processing of the negative open items by assigning all the negative open items in set 590 to the specific allocation method. In one embodiment, the tree structure may be a binary tree. In one embodiment, the tree traversal algorithm may be a depth first search based algorithm.

Workflow 500 may then continue by processing the positive open items. Set 550 includes all positive open items that have yet to be assigned to an allocation method. As shown, set 550 includes positive open items 501-507 but it is to be understood that set 550 includes additional positive open items that are now shown here. Workflow 500 can begin processing of the positive open items by filtering set 550 based on the due date priority from the allocation strategy configuration to generate set 560. Here, the due date priority for bank transfer/cash is invoices that have a due date within three days so therefore, positive open items 503, 504, and 507 which have a due date more than three days away are not included in set 560. Set 560 thus is a subset of set 550 that includes all the positive open items in set 560 that have a due date within three days. This includes positive open items 501, 502, 505, 506, 508, 510, and 511.

Workflow 500 may then continue by calculating the positive target allocation amount for the specific allocation method, for example bank transfer/cash, by adding the planned target allocation amount for the specific allocation method ($200 k) with the total negative allocation amount for all negative open items assigned to the specific allocation method. Here, the total rebate or credit was $90 k so the positive target payment amount would be $200 k+$90 k=$290 k. This means that up to $290 k of positive open items may be assigned to the bank transfer/cash payment method. Workflow 500 then continues by generating a tree structure from positive open items in set 560 (where each positive open item is associated with a node in the tree structure) and performing a traversal on the generated tree structure to select positive open items. Each positive open item is associated with an open item that has an allocation amount due. As the generated tree structure is traversed, workflow 500 maintains a total of the allocation amounts of the positive open items traversed. When the total is close to the positive target allocation amount ($290 k), the traversal ends. In one embodiment, the traversal ends when the total is larger than the positive target allocation amount, or when all positive open items have been traversed. In one another embodiment, the traversal ends when the total is close to but does not exceed the positive target allocation amount, or when all positive open items have been traversed. In another embodiment, the traversal ends when the total is within a margin of the positive target allocation amount, or when all positive open items have been traversed. Here, the total is close to $290 k. Set 570 is the set of positive open items traversed and includes positive open items 501, 502, 506, 507, 511 and 515-517. Workflow 500 may complete processing of the positive open items by assigning all the positive open items in set 570 to the specific allocation method, e.g., to the bank transfer cash payment method. In one embodiment, the tree structure may be a binary tree. In one embodiment, the tree traversal algorithm may be a depth first search based algorithm.

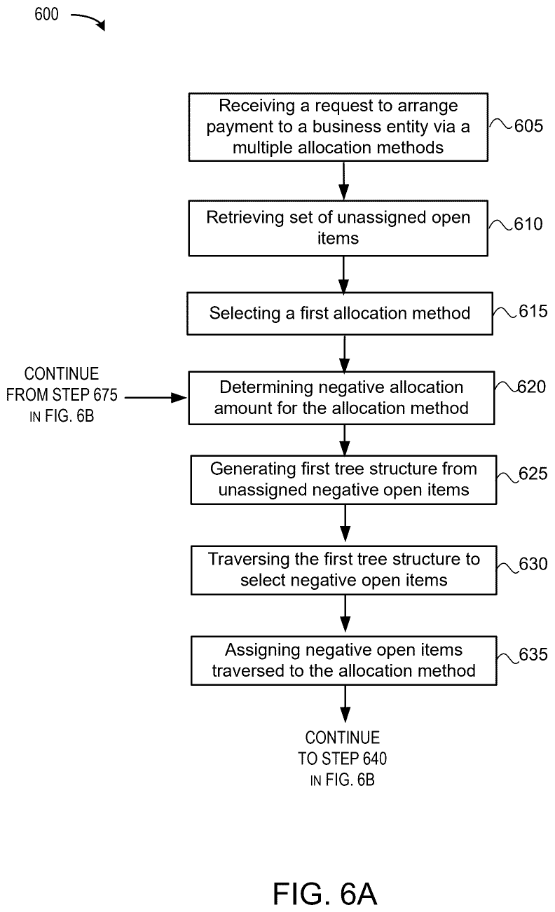

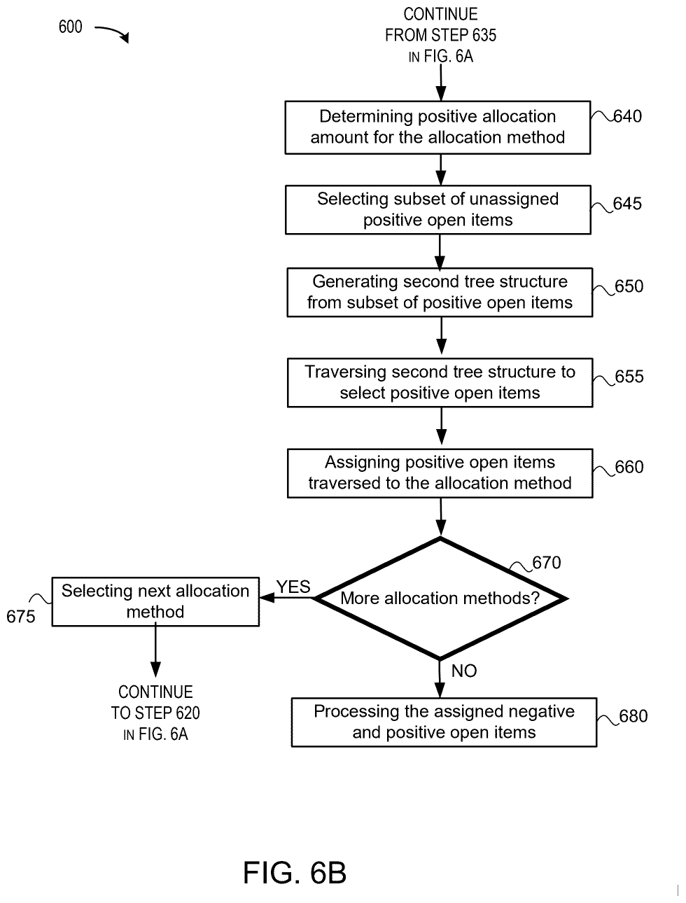

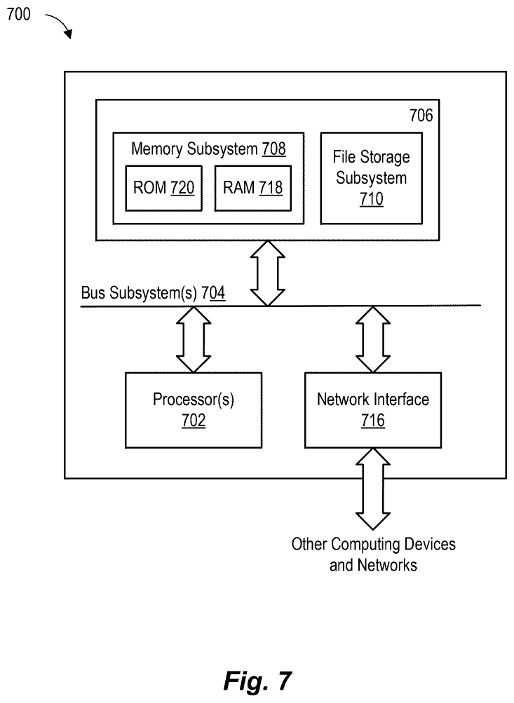

FIGS. 6A and 6B illustrate a workflow for assigning open items to a allocation method according to some embodiments. Workflow 600 may be implemented in computer code and stored within non-transitory computer medium to be executed by a computer. Examples include the computer system shown in FIG. 7. Workflow 600 may begin by receiving a request to arrange allocation to an external entity via multiple allocation methods at step 605. The request may come from a business owner wishing to make an allocation to the external entity that involves a complex allocation scenario with multiple allocation methods. In one embodiment, the request may include a planned target allocation amount for each planned allocation method.

Workflow 600 continues by retrieving a set of unassigned open items at step 610. The unassigned open items may correspond to invoices associated with the external entity for which allocation is to be arranged. These unassigned open items may be invoices still waiting to be processed and paid or completed. The unassigned open items may include positive open items and negative open items. Positive open items correspond to invoices that have a positive invoice amount. Similarly, negative open items correspond to invoices that have a negative invoice amount.

Workflow 600 may continue by processing each allocation method in turn. In one embodiment, the order in which the allocation methods are processed may be configured in the allocation strategy configuration. In another embodiment, the open item matching tool may strategically determine the order in which the allocation methods are to be processed based on an analysis of the allocation strategy configuration. For example, allocation strategy configuration 400 of FIG. 4 has different due date priorities for the different allocation methods. Open item matching tool may determine that receivable bill of exchange should be processed before payable bill of exchange and cheque because the subset of positive open items for the receivable bill of exchange is smaller than the subset of positive open items for the payable bill of exchange and the cheque. This is because the due date priority for the receivable bill of exchange (greater than 10 days) will filter out more positive open items when compared to the due date priority for the payable bill of exchange and cheque (greater than 5 days).

Workflow 600 continues by selecting a first allocation method at step 615 and by determining the negative allocation amount for the allocation method at step 620. In one embodiment, the negative target allocation amount can be calculated based on the negative open item rate setting in the allocation strategy configuration. The open item rate setting can be a monetary value (e.g., $50 k) or can be a percentage of the planned target allocation amount. In the percentage scenario, the negative target allocation amount can be calculated by multiplying the percentage and the planned target allocation amount.

Workflow 600 continues by generating a first tree structure from the unassigned negative open item at step 625. Each node in the first tree structure may correspond to an unassigned negative open item. In one embodiment, the tree structure may be a binary tree. Workflow 600 continues by traversing the first tree structure to select negative open items at 630. In one embodiment, the traversal may be a depth first search algorithm. Traversing the first tree structure may continue until a condition is met. The condition may be that the total sum of the negative allocation amounts of the negative open items traversed is equal to or greater than the negative allocation amount. For example, as the first node of the first tree structure is traversed, the negative allocation amount (e.g., $1 k) from the invoice corresponding to the negative open item traversed can be added to the total sum. After traversal of the first node, the total sum is $1 k. As the second node of the first tree structure is traversed, the negative allocation amount (e.g., $5 k) from the invoice corresponding to the negative open item traversed can be added to the total sum. After traversal of the first node, the total sum is $6 k. This would continue until the total sum is equal to or greater than the negative allocation amount.

After the traversal has ended (either due to total sum being equal to or larger than the negative allocation amount or that all nodes in the first tree structure have been traversed), workflow 600 continues by assigning the negative open items traversed to the allocation method at step 635. Once negative open items are assigned to the allocation method, then will no longer be in the set or pool or unassigned negative open items. This means that the assigned negative open items cannot be assigned to another allocation method. This completes processing of the negative open items for this allocation method. Now the workflow continues by processing the positive open items.

Workflow 600 continues by determining the positive allocation amount for the allocation method at step 640. In one embodiment, determining the positive allocation amount can include adding the planned target allocation amount and the total sum from the invoices of the negative open items traversed. This is because the credits and rebates from the negative open items allow additional positive open items to be assigned to the allocation method. For example, if the planned target payment amount is $300 k for cheque and $45 k is the total sum from the invoices of the negative open items traversed for the cheque, then the positive payment amount is going to be $345 k.

Workflow 600 continues by selecting a subset of the unassigned positive open items at step 645. In one embodiment, the subset may be selected based on a filter from the allocation strategy configuration. The filter may be a date range where positive open items outside of the date range are not considered. For example, the date range could be the due date priority from the allocation strategy configuration 400 of FIG. 4. Once the subset of unassigned positive open items are selected, workflow 600 continues by generating a second tree structure from the subset of positive open items at step 650. Each node in the second tree structure may correspond to an unassigned positive open item from the subset. In one embodiment, the tree structure may be a binary tree. Workflow 600 continues by traversing the second tree structure to select positive open items at 655. In one embodiment, the traversal may be a depth first search algorithm. Traversing the second tree structure may continue until a condition is met. The condition may be that the total sum of the positive allocation amounts of the positive open items traversed is equal to or greater than the positive allocation amount. For example, as the first node of the first tree structure is traversed, the positive payment amount (e.g., $10 k) from the invoice corresponding to the positive open item traversed can be added to the total sum. After traversal of the first node, the total sum is $10 k. As the second node of the first tree structure is traversed, the positive payment amount (e.g., $7 k) from the invoice corresponding to the positive open item traversed can be added to the total sum. After traversal of the second node, the total sum is $17 k. This would continue until the total sum is equal to or greater than the positive payment amount.

After the traversal has ended (either due to total sum being equal to or larger than the negative allocation amount or that all nodes in the second tree structure have been traversed), workflow 600 continues by assigning the positive open items traversed to the allocation method at step 660. Once positive open items are assigned to the allocation method, then will no longer be in the set or pool or unassigned positive open items. This means that the assigned positive open items cannot be assigned to another allocation method. This completes processing of the positive open items for this allocation method.

Workflow 600 continues by determining whether there are more allocation methods to be processed at 670. If there are no more allocation methods to process, then workflow 600 continues by processing the assigned negative and positive open items. In one embodiment, this processing may include marking or changing the status of the assigned negative and positive open items to completed and transmitting an allocation by the allocation method to the external entity. The allocation may be the total sum of the invoices corresponding to assigned positive open items, minus the total sum of the invoices corresponding to the assigned negative open items. If there are more allocation methods to process, workflow 600 continues by select the next allocation method at step 675 and then continues by determining the negative allocation amount for the next allocation method at step 620. As mentioned above, the negative and positive open items assigned to a allocation method would remove them from the pool of unassigned open items and therefore will not be present in subsequently generated tree structures.

FIG. 7 depicts a simplified block diagram of an example computer system 700, which can be used to implement some of the techniques described in the foregoing disclosure. As shown in FIG. 7, system 700 includes one or more processors 702 that communicate with several devices via one or more bus subsystems 704. These devices may include a storage subsystem 706 (e.g., comprising a memory subsystem 708 and a file storage subsystem 710) and a network interface subsystem 716. Some systems may further include user interface input devices and/or user interface output devices (not shown).

Bus subsystem 704 can provide a mechanism for letting the various components and subsystems of system 700 communicate with each other as intended. Although bus subsystem 704 is shown schematically as a single bus, alternative embodiments of the bus subsystem can utilize multiple buses.

Network interface subsystem 716 can serve as an interface for communicating data between system 700 and other computer systems or networks. Embodiments of network interface subsystem 716 can include, e.g., Ethernet, a Wi-Fi and/or cellular adapter, a modem (telephone, satellite, cable, etc.), and/or the like.

Storage subsystem 706 includes a memory subsystem 708 and a file/disk storage subsystem 710. Subsystems 708 and 710 as well as other memories described herein are examples of non-transitory computer-readable storage media that can store executable program code and/or data that provide the functionality of embodiments of the present disclosure.

Memory subsystem 708 comprise one or more memories including a main random access memory (RAM) 718 for storage of instructions and data during program execution and a read-only memory (ROM) 720 in which fixed instructions are stored. File storage subsystem 710 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that system 700 is illustrative and many other configurations having more or fewer components than system 700 are possible.

The above description illustrates various embodiments of the present invention along with examples of how aspects of the present invention may be implemented. The above examples and embodiments should not be deemed to be the only embodiments and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

### FURTHER EXAMPLES

Each of the following non-limiting features in the following examples may stand on its own or may be combined in various permutations or combinations with one or more of the other features in the examples below. In various embodiments, the present disclosure may be implemented as a processor or method.

In some embodiments the present disclosure includes a method, implemented in a computing system comprising a memory and one or more processors, comprising receiving a request to allocate a predefined resource to an external entity, the allocation including a plurality of applicable allocation methods, each allocation method having a planned target resource amount, retrieving a set of unassigned open items associated with the external entity, each unassigned open item corresponding to an open item amount that has yet to be assigned to one of the plurality of allocation methods, wherein the set of unassigned open items include a plurality of positive open items with positive open item amounts and a plurality of negative open items with negative open item amounts, and for each of the plurality of allocation methods: determining a negative target resource amount according to an allocation strategy configuration and the planned target resource amount that corresponds with the allocation method, generating a first tree structure from the plurality of negative open items, wherein each of the plurality of negative open items is a node in the first tree structure, applying a first tree traversal algorithm to traverse the first tree structure, wherein the traversal is constrained by the negative target resource amount, assigning the negative open items traversed in the first tree structure to the planned allocation method, determining a positive target resource amount according to the negative target resource amount and the planned target resource amount that corresponds with the allocation method, selecting a subset of the plurality of positive open items according to an allocation strategy configuration, generating a second tree structure from the subset of positive open items, wherein each of the plurality of negative open items is a node in the first tree structure, applying a second tree traversal algorithm to traverse the second tree structure wherein the traversal is constrained by the positive target resource amount, and assigning the positive open items traversed in the second tree structure to the allocation method.

In one embodiment, applying the first tree traversal algorithm to traverse the first tree structure includes summing the open item amount corresponding to the negative open items traversed and comparing the sum to the negative target resource amount.

In one embodiment, the first tree traversal algorithm and the second tree traversal algorithm are the same.

In one embodiment, the first tree traversal algorithm is a depth first search algorithm.

In one embodiment, the allocation strategy configuration includes at least one of a negative open item rate, a due date priority, and a result tolerance rate for each allocation method.

In one embodiment, determining the negative target resource amount includes multiplying the planned target resource amount and the negative open item rate corresponding to the allocation method.

In one embodiment, applying the first tree traversal algorithm to traverse the first tree structure includes summing the open item amount corresponding to the negative open items traverse, and determining whether the sum is within the result tolerance rate of the negative target resource amount, the result tolerance rate corresponding to the allocation method.

In one embodiment, selecting a subset of the plurality of positive open items includes selecting positive open items from the plurality of positive open items that are due within the due date priority corresponding to the allocation method.

In one embodiment, determining the positive target resource amount includes subtracting the open item amounts corresponding to the negative open items assigned to the planned allocation method from the planned target resource amount that corresponds to the allocation method.

In some embodiments, the present disclosure includes a computing system comprising one or more processors, a non-transitory computer-readable medium storing a program executable by the one or more processors, the program comprising sets of instructions for: receiving a request to allocate a predefined resource to an external entity, the allocation including a plurality of allocation methods, each allocation method having a planned target resource amount, retrieving a set of unassigned open items associated with the external entity, each unassigned open item corresponding to an open item amount that has yet to be assigned to one of the plurality of allocation methods, wherein the set of unassigned open items include a plurality of positive open items with positive open item amounts and a plurality of negative open items with negative open item amounts, and for each of the plurality of allocation methods: determining a negative target resource amount according to an allocation strategy configuration and the planned target resource amount that corresponds with the allocation method, generating a first tree structure from the plurality of negative open items, wherein each of the plurality of negative open items is a node in the first tree structure, applying a first tree traversal algorithm to traverse the first tree structure, wherein the traversal is constrained by the negative target resource amount, assigning the negative open items traversed in the first tree structure to the planned allocation method, determining a positive target resource amount according to the negative target resource amount and the planned target resource amount that corresponds with the allocation method, selecting a subset of the plurality of positive open items according to an allocation strategy configuration, generating a second tree structure from the subset of positive open items, wherein each of the plurality of negative open items is a node in the first tree structure, applying a second tree traversal algorithm to traverse the second tree structure wherein the traversal is constrained by the positive target resource amount, and assigning the positive open items traversed in the second tree structure to the allocation method.

In some embodiments, the present disclosure includes a non-transitory computer-readable medium storing a program executable by one or more processors, the program comprising sets of instructions for receiving a request to allocate a predefined resource to an external entity, the allocation including a plurality of applicable allocation methods, each allocation method having a planned target resource amount, retrieving a set of unassigned open items associated with the external entity, each unassigned open item corresponding to an open item amount that has yet to be assigned to one of the plurality of allocation methods, wherein the set of unassigned open items include a plurality of positive open items with positive open item amounts and a plurality of negative open items with negative open item amounts, and for each of the plurality of allocation methods: determining a negative target resource amount according to an allocation strategy configuration and the planned target resource amount that corresponds with the allocation method, generating a first tree structure from the plurality of negative open items, wherein each of the plurality of negative open items is a node in the first tree structure, applying a first tree traversal algorithm to traverse the first tree structure, wherein the traversal is constrained by the negative target resource amount, assigning the negative open items traversed in the first tree structure to the planned allocation method, determining a positive target resource amount according to the negative target resource amount and the planned target resource amount that corresponds with the allocation method, selecting a subset of the plurality of positive open items according to an allocation strategy configuration, generating a second tree structure from the subset of positive open items, wherein each of the plurality of negative open items is a node in the first tree structure, applying a second tree traversal algorithm to traverse the second tree structure wherein the traversal is constrained by the positive target resource amount, and assigning the positive open items traversed in the second tree structure to the allocation method.

What is claimed is:

1. A method, implemented in a computing system comprising a memory and one or more processors, comprising:
receiving a request to allocate a predefined resource to an external entity, the allocation including a plurality of applicable allocation methods, each allocation method having a planned target resource amount;
retrieving a set of unassigned open items associated with the external entity, each unassigned open item corresponding to an open item amount that has yet to be assigned to one of the plurality of allocation methods, wherein the set of unassigned open items include a plurality of positive open items with positive open item amounts and a plurality of negative open items with negative open item amounts; and
for each of the plurality of allocation methods:
determining a negative target resource amount according to an allocation strategy configuration and the planned target resource amount that corresponds with the allocation method;
generating a first tree structure from the plurality of negative open items, wherein each of the plurality of negative open items is a node in the first tree structure;
applying a first tree traversal algorithm to traverse the first tree structure, wherein the traversal is constrained by the negative target resource amount;
assigning the negative open items traversed in the first tree structure to the planned allocation method;
determining a positive target resource amount according to the negative target resource amount and the planned target resource amount that corresponds with the allocation method;
selecting a subset of the plurality of positive open items according to an allocation strategy configuration;
generating a second tree structure from the subset of positive open items, wherein each of the plurality of negative open items is a node in the first tree structure;
applying a second tree traversal algorithm to traverse the second tree structure wherein the traversal is constrained by the positive target resource amount; and
assigning the positive open items traversed in the second tree structure to the allocation method.

2. The method as in claim 1, wherein applying the first tree traversal algorithm to traverse the first tree structure includes summing the open item amount corresponding to the negative open items traversed and comparing the sum to the negative target resource amount.

3. The method as in claim 1, wherein the first tree traversal algorithm and the second tree traversal algorithm are the same.

4. The method as in claim 3, wherein the first tree traversal algorithm is a depth first search algorithm.

5. The method as in claim 1, wherein the allocation strategy configuration includes at least one of a negative open item rate, a due date priority, and a result tolerance rate for each allocation method.

6. The method as in claim 5, wherein determining the negative target resource amount includes multiplying the planned target resource amount and the negative open item rate corresponding to the allocation method.

7. The method as in claim 5, wherein applying the first tree traversal algorithm to traverse the first tree structure includes:
summing the open item amount corresponding to the negative open items traversed; and
determining whether the sum is within the result tolerance rate of the negative target resource amount, the result tolerance rate corresponding to the allocation method.

8. The method as in claim 5, wherein selecting a subset of the plurality of positive open items includes selecting positive open items from the plurality of positive open items that are due within the due date priority corresponding to the allocation method.

9. The method as in claim 1, wherein determining the positive target resource amount includes subtracting the open item amounts corresponding to the negative open items assigned to the planned allocation method from the planned target resource amount that corresponds to the allocation method.

10. A computing system comprising:
one or more processors;
a non-transitory computer-readable medium storing a program executable by the one or more processors, the program comprising sets of instructions for:
receiving a request to allocate a predefined resource to an external entity, the allocation including a plurality of allocation methods, each allocation method having a planned target resource amount;
retrieving a set of unassigned open items associated with the external entity, each unassigned open item corresponding to an open item amount that has yet to be assigned to one of the plurality of allocation methods, wherein the set of unassigned open items include a plurality of positive open items with positive open item amounts and a plurality of negative open items with negative open item amounts; and
for each of the plurality of allocation methods:
determining a negative target resource amount according to an allocation strategy configuration and the planned target resource amount that corresponds with the allocation method;
generating a first tree structure from the plurality of negative open items, wherein each of the plurality of negative open items is a node in the first tree structure;
applying a first tree traversal algorithm to traverse the first tree structure, wherein the traversal is constrained by the negative target resource amount;
assigning the negative open items traversed in the first tree structure to the planned allocation method;
determining a positive target resource amount according to the negative target resource amount and the planned target resource amount that corresponds with the allocation method;
selecting a subset of the plurality of positive open items according to an allocation strategy configuration;
generating a second tree structure from the subset of positive open items, wherein each of the plurality of negative open items is a node in the first tree structure;
applying a second tree traversal algorithm to traverse the second tree structure wherein the traversal is constrained by the positive target resource amount; and
assigning the positive open items traversed in the second tree structure to the allocation method.

11. The computing system of claim 10, wherein the first tree traversal algorithm is a depth first search algorithm.

12. The computing system of claim 10, wherein the allocation strategy configuration includes at least one of a negative open item rate, a due date priority, and a result tolerance rate for each allocation method.

13. The computing system of claim 12, wherein applying the first tree traversal algorithm to traverse the first tree structure includes:
summing the open item amount corresponding to the negative open items traversed;
determining whether the sum is within the result tolerance rate of the negative target resource amount, the result tolerance rate corresponding to the allocation method.

14. The computing system of claim 12, wherein selecting a subset of the plurality of positive open items includes selecting positive open items from the plurality of positive open items that are due within the due date priority corresponding to the allocation method.

15. A non-transitory computer-readable medium storing a program executable by one or more processors, the program comprising sets of instructions for:
receiving a request to allocate a predefined resource to a external entity, the allocation including a plurality of allocation methods, each allocation method having a planned target resource amount;
retrieving a set of unassigned open items associated with the external entity, each unassigned open item corresponding to an open item amount that has yet to be assigned to one of the plurality of allocation methods, wherein the set of unassigned open items include a plurality of positive open items with positive open item amounts and a plurality of negative open items with negative open item amounts; and
for each of the plurality of allocation methods:
determining a negative target resource amount according to a allocation strategy configuration and the planned target resource amount that corresponds with the allocation method;
generating a first tree structure from the plurality of negative open items, wherein each of the plurality of negative open items is a node in the first tree structure;
applying a first tree traversal algorithm to traverse the first tree structure, wherein the traversal is constrained by the negative target resource amount;
assigning the negative open items traversed in the first tree structure to the planned allocation method;
determining a positive target resource amount according to the negative target resource amount and the planned target resource amount that corresponds with the allocation method;
selecting a subset of the plurality of positive open items according to a allocation strategy configuration;
generating a second tree structure from the subset of positive open items, wherein each of the plurality of negative open items is a node in the first tree structure;
applying a second tree traversal algorithm to traverse the second tree structure wherein the traversal is constrained by the positive target resource amount; and
assigning the positive open items traversed in the second tree structure to the allocation method.

16. The non-transitory computer-readable medium of claim 15, wherein the first tree traversal algorithm is a depth first search algorithm.

17. The non-transitory computer-readable medium of claim 15, wherein the allocation strategy configuration includes at least one of a negative open item rate, a due date priority, and a result tolerance rate for each allocation method.

18. The non-transitory computer-readable medium of claim 17, wherein applying the first tree traversal algorithm to traverse the first tree structure includes:
summing the open item amount corresponding to the negative open items traversed;
determining whether the sum is within the result tolerance rate of the negative target resource amount, the result tolerance rate corresponding to the allocation method.

19. The non-transitory computer-readable medium of claim 17, wherein selecting a subset of the plurality of positive open items includes selecting positive open items from the plurality of positive open items that are due within the due date priority corresponding to the allocation method.

20. The non-transitory computer-readable medium of claim 15, wherein determining the positive target resource amount includes subtracting the open item amounts corresponding to the negative open items assigned to the planned allocation method from the planned target resource amount that corresponds to the allocation method.
